(19) United States
(12) Patent Application Publication
(10) Pub. No.: US 2025/0313484 A1
(43) Pub. Date: Oct. 9, 2025

(54) ANODE ACTIVE MATERIAL FOR SECONDARY BATTERIES AND MANUFACTURING METHOD THEREOF

(71) Applicant: UNIVERSITY-INDUSTRY COOPERATION GROUP OF KYUNG HEE UNIVERSITY, Yongin-si (KR)

(72) Inventors: Sun Ho JEONG, Yongin-si (KR); Yeong Je LEE, Jeonju-si (KR)

(73) Assignee: UNIVERSITY-INDUSTRY COOPERATION GROUP OF KYUNG HEE UNIVERSITY, Yongin-si (KR)

(21) Appl. No.: 19/046,826

(22) Filed: Feb. 6, 2025

(30) Foreign Application Priority Data
Apr. 8, 2024 (KR) 10-2024-0047052

(51) Int. Cl. C01B 33/12

(52) U.S. Cl. CPC C01B 33/12; C01P 2002/85; C01P 2004/84; C01P 2006/40

(57) ABSTRACT

Disclosed are a negative electrode active material for secondary batteries and a method of manufacturing the same. The method of manufacturing the negative electrode active material for secondary batteries of the present disclosure includes manufacturing a negative electrode active material precursor, the negative electrode active material precursor including a silica precursor including an organic functional group; and a carbon layer surrounding a surface of the silica precursor including the organic functional group; heat-treating the negative electrode active material precursor to manufacture a negative electrode active material intermediate including a first silicon composite; and photo-processing the negative electrode active material intermediate to manufacture a negative electrode active material including a second silicon composite. The negative electrode active material for secondary batteries according to an embodiment of the present disclosure can implement high capacity characteristics.

### CROSS-REFERENCE TO RELATED APPLICATION

This application claims priority to Korean Patent Application No. 10-2024-0047052, filed on Apr. 8, 2024 in the Korean Intellectual Property Office, the disclosure of which is incorporated herein by reference.

### BACKGROUND OF THE DISCLOSURE

### Field of the Disclosure

The present disclosure relates to a negative electrode active material for secondary batteries and a method of manufacturing the same. More particularly, the present disclosure relates to a negative electrode active material precursor including an organic functional group and carbon layer introduced thereinto to improve a light absorption rate, a negative electrode active material manufactured using the negative electrode active material precursor and a method of manufacturing the negative electrode active material.

### Description of the Related Art

Carbon-based negative electrode active materials are widely used as negative electrode active materials for lithium secondary batteries because the carbon-based negative electrode active materials have stable electrochemical reactivity, excellent lithium-ion storage capacity, reasonable price, etc. However, carbon-based negative electrode active materials have the disadvantage of having a low theoretical capacity of 372 mAh/g. Accordingly, silicon-based negative electrode active materials have been attracting attention as promising materials due to their significantly higher theoretical capacity. However, silica should be reduced to silicon oxide, etc. to utilize silica as a silicon-based negative electrode active material, and conventionally, silica was reduced by heat treatment at a high temperature in a hydrogen atmosphere for a long time. Therefore, in this present disclosure, silicon oxide is generated through light treatment to shorten wasted heat treatment time, and a means for improving a light absorption rate for efficient light treatment is introduced to complete the present invention.

### RELATED ART DOCUMENT

### Patent Document

Korean Patent No. 10-0578870, entitled “NEGATIVE ACTIVE MATERIAL FOR LITHIUM SECONDARYBATTERY, METHOD OF PREPARING SAME, AND LITHIUMSECONDARY BATTERY COMPRISING SAME”

### SUMMARY OF THE DISCLOSURE

Therefore, the present disclosure has been made in view of the above problems, and it is an object of the present disclosure to provide a negative electrode active material for next-generation lithium secondary batteries with high capacity.

It is another object of the present disclosure to provide a method of reducing a silica precursor including an organic functional group by instantaneous rapid photo-processing to utilize it as a negative electrode active material.

It is yet another object of the present disclosure to provide optimal conditions for photo-processing the silica precursor including the organic functional group.

In accordance with an aspect of the present disclosure, the above and other objects can be accomplished by the provision of a method of manufacturing a negative electrode active material for secondary batteries, the method including: manufacturing a negative electrode active material precursor, the negative electrode active material precursor including a silica precursor including an organic functional group; and a carbon layer surrounding a surface of the silica precursor including the organic functional group; heat-treating the negative electrode active material precursor to manufacture a negative electrode active material intermediate including a first silicon composite; and photo-processing the negative electrode active material intermediate to manufacture a negative electrode active material including a second silicon composite.

According to an embodiment, the negative electrode active material intermediate may include a first silicon composite; carbon particles contained in the first silicon composite; and the carbon layer surrounding a surface of the first silicon composite, and the negative electrode active material may include a second silicon composite, the carbon particles contained in the second silicon composite; and the carbon layer surrounding a surface of the second silicon composite.

According to an embodiment, the organic functional group may be one selected from the group consisting of a vinyl group, a thiol group, a methyl group, an ethyl group, a phenyl group, an acryloxy group, a glycidyloxy group, and a mercapto group.

According to an embodiment, in the heat-treating of the negative electrode active material precursor, the carbon layer may absorb heat so that the silica precursor including the organic functional group is reduced to the first silicon composite, and the first silicon composite may include at least one of silica (SiO₂) and silicon oxide (SiOₓ), where 0<x<2.

According to an embodiment, in the heat-treating of the negative electrode active material precursor, the organic functional group may be thermally decomposed and, thus, converted to the carbon particles.

According to an embodiment, in the photo-processing of the negative electrode active material intermediate, the carbon layer and the carbon particles may absorb light so that the first silicon composite is reduced to the second silicon composite, and the second silicon composite may include at least one of silica (SiO₂), silicon oxide (SiOₓ) and silicon (Si).

According to an embodiment, the heat treatment may be performed at 300° C. to 1,500° C.

According to an embodiment, the carbon layer may have a thickness of 0.5 nm to 100 nm.

According to an embodiment, the photo-processing may be white light irradiation or laser irradiation.

According to an embodiment, the laser irradiation may be performed with a laser having a wavelength of 300 nm to 20 μm.

According to an embodiment, the laser irradiation may be performed with an intensity of 1 W to 10 W.

According to an embodiment, the carbon layer may include one selected from the group consisting of graphite, carbon nanotubes, graphene oxide, graphene, graphene nanoplatelet and a carbon film deposited with hydrocarbon gas.

In accordance with another aspect of the present disclosure, provided is a negative electrode active material for secondary batteries, manufactured according to the method of manufacturing a negative electrode active material for secondary batteries according to the present disclosure.

According to an embodiment, the second silicon composite may include at least one of silica (SiO₂), silicon oxide (SiOₓ) and silicon (Si), where 0<x<2.

According to an embodiment, the carbon layer may be one selected from the group consisting of graphite, carbon nanotubes, graphene oxide, graphene, graphene nanoplatelet and a carbon film deposited with hydrocarbon gas.

According to an embodiment, the negative electrode active material for secondary batteries may have an initial capacity of 950 mAh/g to 4,200 mAh/g.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1A illustrates the schematic diagram of a powder of a negative electrode active material precursor manufactured according to an embodiment of the present disclosure;

FIG. 1B illustrates the schematic diagram of a negative electrode active material intermediate powder manufactured according to an embodiment of the present disclosure;

FIG. 1C illustrates the schematic diagram of a negative electrode active material powder manufactured according to an embodiment of the present disclosure;

FIG. 2 illustrates the initial charge/discharge graph of a cell manufactured in Comparative Example 1;

FIG. 3 illustrates the initial charge/discharge graph of a cell manufactured in Comparative Example 2;

FIG. 4 illustrates the initial charge/discharge graph of a cell manufactured in Example 1;

FIG. 5 illustrates the initial charge/discharge graph of a cell manufactured in Comparative Example 3;

FIG. 6 illustrates the initial charge/discharge graph of a cell manufactured in Example 2;

FIG. 7 illustrates the initial charge/discharge graph of a cell manufactured in Example 3;

FIG. 8 illustrates the initial charge/discharge graph of a cell manufactured in Example 4;

FIG. 9 illustrates the current density-dependent capacity measurement results of the cells manufactured in Comparative Example 1 and Example 4;

FIG. 10 illustrates the current density-dependent long-term charging/discharging measurement results of the cells manufactured in Comparative Example 1 and Example 4; and

FIG. 11 illustrates the photograph of the carbon atoms (C) of Example 4 taken by energy-dispersive X-ray spectroscopy (EDS), and FIG. 12 illustrates the photograph of the silicon atoms (Si) of Example 4 taken by EDS.

### DETAILED DESCRIPTION OF THE DISCLOSURE

Embodiments of the disclosure will now be described more fully with reference to the accompanying drawings and contents disclosed in the drawings. However, the disclosure should not be construed as limited to the embodiments described herein.

The terminology used in the present disclosure serves the purpose of describing particular embodiments only and is not intended to limit the disclosure. As used in the disclosure and the appended claims, the singular forms “a”, “an” and “the” are intended to include the plural forms as well, unless context clearly indicates otherwise. It will be further understood that the terms “includes” and/or “including,” when used in this specification, specify the presence of stated features, steps, operations, elements, and/or components, but do not preclude the presence or addition of one or more other features, steps, operations, elements, components, and/or groups thereof.

It should not be understood that arbitrary aspects or designs disclosed in “embodiments”, “examples”, “aspects”, etc. used in the specification are more satisfactory or advantageous than other aspects or designs.

In addition, the expression “or” means “inclusive or” rather than “exclusive or”. That is, unless otherwise mentioned or clearly inferred from context, the expression “x uses a or b” means any one of natural inclusive permutations.

Further, as used in the description of the disclosure and the appended claims, the singular forms “a”, “an” and “the” are intended to include the plural forms as well, unless context clearly indicates otherwise.

In addition, when an element such as a layer, a film, a region, and a constituent is referred to as being “on” another element, the element can be directly on another element or an intervening element can be present.

Conventionally, long-term high-temperature heat treatment was performed in a hydrogen atmosphere, etc. to reduce silica. However, high-temperature heat treatment is disadvantageously not economical because it is performed for a long time at 600° C. or higher while flowing expensive hydrogen gas using an electric furnace. Therefore, in the present disclosure, light was irradiated to shorten the time for applying energy for the reduction of silica, and at this time, a material for light absorption was introduced to silica to increase a light absorption rate such that high-temperature energy can be applied rapidly.

A method of manufacturing a negative electrode active material for secondary batteries according to the present disclosure includes a step of manufacturing a negative electrode active material precursor including a silica precursor including an organic functional group and a carbon layer surrounding the surface of the silica precursor including the organic functional group; a step of heat-treating the negative electrode active material precursor to manufacture a negative electrode active material intermediate including a first silicon composite; and a step of photo-processing the negative electrode active material intermediate to manufacture a negative electrode active material including a second silicon composite. The silica precursor may be one selected from among silica (SiO₂), silicon oxide (SiOₓ) and silicon (Si).

Here, the negative electrode active material intermediate may include the first silicon composite, carbon particles included in the first silicon composite, first silicon composite and a carbon layer covering the surface of the first silicon composite, and the negative electrode active material may include the second silicon composite, carbon particles included in the second silicon composite and a carbon layer covering the surface of the second silicon composite.

That is, the present disclosure provides a method of performing photothermal treatment on the silica precursor including the organic functional group to manufacture a negative electrode active material including a reduced silicon-based material, and a method of introducing a carbon layer and carbon particles to improve the absorption efficiency of heat energy and light energy upon the photothermal treatment.

According to an embodiment, the organic functional group may be one selected from the group consisting of a vinyl group, a thiol group, a methyl group, an ethyl group, a phenyl group, an acryloxy group, a glycidyloxy group, and a mercapto group.

Hereinafter, the respective steps of the method of manufacturing the negative electrode active material for secondary batteries are described in detail.

First, the silica precursor including the organic functional group is manufactured from an organically modified silane. In this specification, “organically modified silane” refers to a silane including an organic functional group. The method of manufacturing the silica precursor including the organic functional group is described in more detail as follows: First, a surfactant is added to a mixed solution of alcohol and water and stirred. In the mixed solution of alcohol and water, a volume ratio of alcohol to water may be 0.30 to 0.80, preferably 0.40 to 0.60. The alcohol may be one selected from the group consisting of ethanol, methanol, isopropyl alcohol, methoxyethanol and acetone.

The surfactant may include an ionic surfactant and may be one selected from the group consisting of cetrimonium bromide (CTAB), triethylamine hydrochloride (TAHC), benzethonium chloride (BTC), cetylpyridinium chloride (CPC), dimethyldioctadecylammonium chloride (DOAC), sodiumdodecylsulfate (SDS), sodiumdodecylbenzenesulfonate (SDBS), and dodecyltrimethylammonium bromide (DTAB).

Next, an organically modified silane is added and stirred to generate a silica precursor. The silica precursor may exist in a particle form and may have a pore structure due to the introduction of an emulsion mechanism in which alcohol and water are mixed and have an oil-in-water composition. When the emulsion is formed, the synthesis reaction of a silica precursor may be promoted on the surface of the emulsion by using an ionic surfactant that can chemically bond with an organically modified silane that has a charge. In addition, the organically modified silane contained in the emulsion may be synthesized in the form of a shell through a chemical reaction with water and a catalyst contained outside the emulsion. That is, the emulsion mechanism is a reaction mechanism that allows the shell of the silica precursor to grow through the diffusion of water and a catalyst into the emulsion. In addition, silica particles with pore structures of various pore sizes may be synthesized by controlling the reaction time and speed of the emulsion mechanism. The porous silica precursor has the advantage of being able to control electrical and electrochemical properties not only according to the physicochemical properties of the material itself but also according to the volume fraction of its internal structure containing air.

Next, a catalyst is added and stirred. The catalyst may be an acid or base catalyst. The acid catalyst may be hydrochloric acid (HCl) or sulfuric acid (H₂SO₄), and the base catalyst may be ammonium hydroxide (NH₄OH) or sodium hydroxide (NaOH). By using the catalyst, a silica precursor in the form of particles, not a silica precursor in the form of a polymer chain, is synthesized from the organically modified silane. That is, silica precursor particles may be synthesized through the hydration and polymerization reaction of the organically modified silane in a radial direction rather than a linear direction.

Next, a surface modifier is added and stirred to obtain a precipitate. Silica precursor nanoparticles with a low degree of agglomeration, i.e., silica precursor nanoparticles that do not clump together well, can be obtained from the precipitate. Silica precursor nanoparticles having controlled agglomeration may be produced to a size of 100 nm to 700 nm, and pores may not exist inside the silica particles. If pores are present inside the silica particles, pores may be produced to a size of 1 nm to 500 nm.

Here, the surface modifier is a polymer including a functional group having polarity and charge, and the polar functional group may be one or more of a sulfonyl group, an amino group, an amide group, an ether group, a carboxyl group and a hydroxyl group. In addition, the surface modifier may be one of poly(sodium 4-styrene-sulfonate) (PSS), poly(allyl-amine hydrochloride) (PAH), poly(diallyldimethylammonium chloride) (PDAC), polyvinyl pyrrolidone (PVP), poly(N,N-dimethylacrylamide), poly(2-methyl-2-oxazoline), polyvinyl alcohol (PVA), polyethylenimine (PEI), polypropylene glycol (PPG), polyethylene glycol (PEG) and poly(acrylic acid (PAA).

The silica precursor nanoparticles are formed as colloidal particles, and the colloidal particles have a mutual attraction therebetween to attract each other. Due to this attraction, the agglomeration phenomenon occurs. To prevent this, a surface modifier may be used. The surface charge is formed according to the behavior of the surface modifier adsorbing to the surface of the silica particles, and the surface modifier enhances the surface charge of the silica precursor particles. This causes repulsion between charges and a significant decrease in the agglomeration of the silica precursor particles.

Silica precursor particles with severe particle aggregation make it impossible to manufacture a silica composite homogeneous with the materials constituting the carbon layer. Accordingly, it is preferable to sequentially proceed with combining with the materials forming the carbon layer after adding the surface modification additive in the silica precursor particle synthesis step.

Next, the step of manufacturing a negative electrode active material precursor that includes a silica precursor including an organic functional group; and a carbon layer surrounding the surface of the silica precursor including the organic functional group is described in detail as follows: A mixture in which the precipitate has been dispersed is added to a dispersion solution containing materials constituting the carbon layer, and then stirred. The resultant product is dried at high temperature to obtain a negative electrode active material precursor. The negative electrode active material precursor includes a silica precursor; and a carbon layer covering the surface of the silica precursor.

The dispersion solution containing materials constituting the carbon layer means a solution in which a carbon-based material is dispersed in a polar solvent. Preferably, water may be used as a polar solvent. When the precipitate, i.e., a mixture in which the silica precursor is dispersed, is added to the dispersion solution containing materials constituting the carbon layer, it may be injected dropwise while stirring for a homogeneous interfacial reaction.

Meanwhile, the silica precursor and the dispersion solution containing the carbon-based material constituting the carbon layer may be mixed in a weight ratio of 40:60 to 90:10, preferably a weight ratio of 60:40 to 80:20. The silica precursor particles increase the capacity of the secondary battery negative electrode through electrochemical activity, and the carbon layer composed of the carbon-based material provides electrical conductivity to the secondary battery negative electrode while improving long-term charge-discharge characteristics. Accordingly, if the content of the silica precursor is too low in a mixing ratio of the silica precursor to the dispersion solution containing the carbon-based material constituting the carbon layer, a secondary battery with a high capacity may not be manufactured, and conversely, if the content of the carbon-based material is too low, sufficient electrical conductivity and charge/discharge stability may not be secured.

Next, the step of heat-treating the negative electrode active material precursor to manufacture a negative electrode active material intermediate is described in detail as follows: According to an embodiment, in the step of heat-treating a negative electrode active material precursor, the silica precursor including the organic functional group may be reduced into a first silicon composite, and the first silicon composite may include at least one of silica (SiO₂) and silicon oxide (SiOₓ). Here, the carbon layer includes a material capable of reducing a silica precursor through carbothermal reduction.

According to an embodiment, the organic functional group may be converted into carbon particles by thermal decomposition. The organic functional group existing in a state of being bonded to the silica precursor may be preferably a vinyl group. The organic functional group may be converted into carbon particles through a carbonization reaction. Here, the diameter of the carbon particles may be formed to be 1 nm to 100 nm. Carbon particles may induce the homogeneous carbothermal reduction of the first silicon composite in the negative electrode active material intermediate. Carbon particles with a diameter larger than 100 nm may locally cause the reduction of the first silicon composite, thereby obtaining a heterogeneously reduced silicon composite.

Meanwhile, the heat treatment step may be carried out in a heating furnace in an inert atmosphere, or preferably, plasma heating, microwave heating or Joule heating capable of initiating the carbothermal reduction of a carbon layer including a carbon-based material may be carried out. Furnace heating, plasma heating, microwave heating and Joule heating may be applied to applied to films coated with powder or slurry.

According to an embodiment, heat treatment may be performed at 300° C. to 1,500° C. When the heat treatment temperature is lower than 300° C., the carbonization reaction of the organic functional group included in the silica precursor does not sufficiently proceed. The organic functional group contained in the silica precursor undergoes a carbonization reaction during heat treatment and is converted into carbon particles with a high light absorption rate, and the carbon particles play a role in reducing silica and silicon oxide once more during subsequent photo-processing. On the other hand, when the heat treatment temperature is higher than 1,500° C., side reactions may occur inside the negative electrode active material intermediate, forming impurities. These impurities may interfere with the absorption of light.

In addition, the heat treatment may be performed for 20 minutes to 90 minutes. In the present disclosure, since silica undergoes both heat treatment and photo-processing, the silica reduction efficiency may be the same as or greater than that of performing only heat treatment for a long time even if the heat treatment is performed for a relatively short time, compared to the case where only heat treatment is performed. If the heat treatment is performed for less than 20 minutes, the silica reduction efficiency is similar to that of the case where only light irradiation is performed, so there is no point in performing additional heat treatment. If the heat treatment is performed for more than 90 minutes, the time is not significantly shortened compared to the conventional case of performing only heat treatment. In the case of an existing method of performing heat treatment by flowing expensive hydrogen gas, heat treatment at about 800° C. for 6 hours or more is required to initiate a sufficient reduction reaction.

Next, the step of photo-processing the negative electrode active material intermediate to manufacture a negative electrode active material is described in detail as follows: According to an embodiment, in the step of photo-processing a negative electrode active material intermediate, the carbon layer and the carbon particles absorb light so that the first silicon composite is reduced to the second silicon composite, and the second silicon composite may include at least one of silica (SiO₂), silicon oxide (SiOₓ) and silicon (Si). The carbon layer and the carbon particles absorb light and transfer light energy to the first silicon composite, thereby allowing various silicon-based materials constituting the first silicon composite to be reduced once more. The negative electrode active material including silicon-based materials may exhibit greater capacity as it contains silicon-based materials with a higher reduction and, accordingly, lower oxidation number. In addition, carbon particles constitute the negative electrode active material and, when applied to secondary batteries, also play a role in providing conductivity.

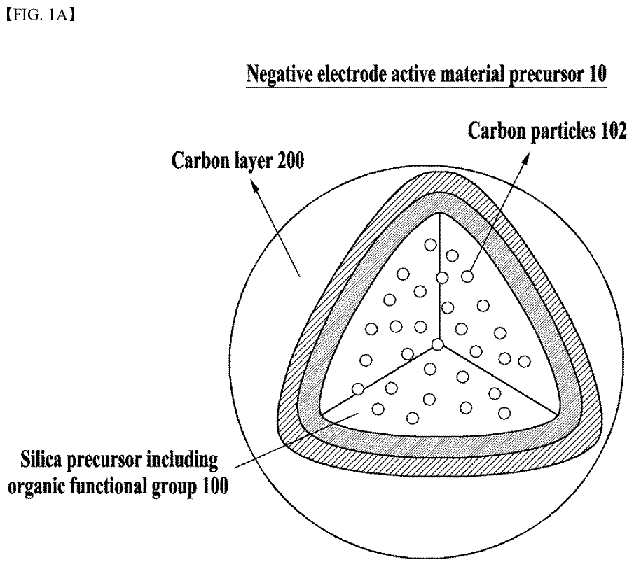

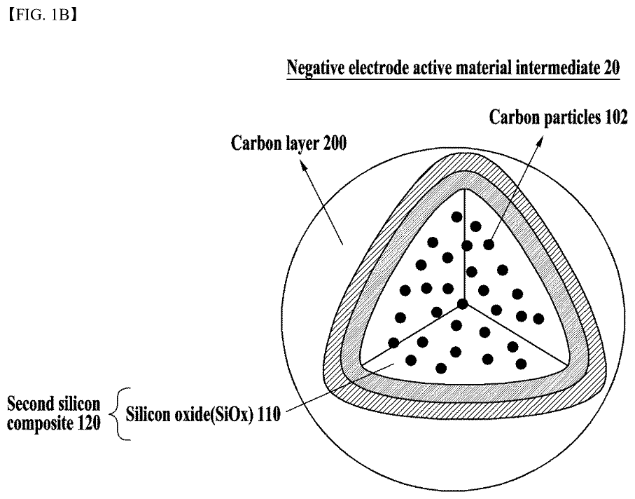

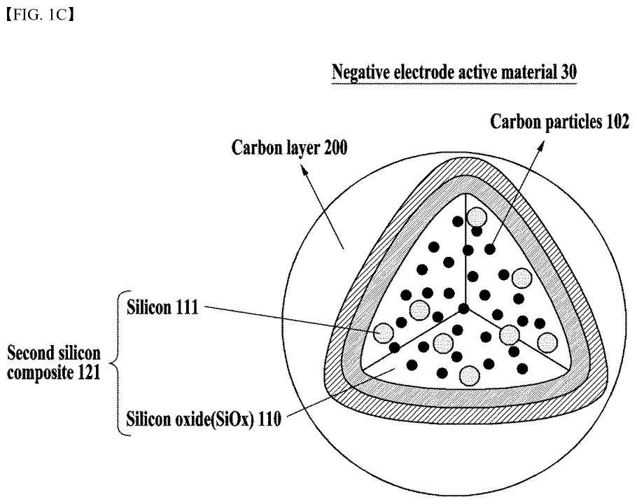

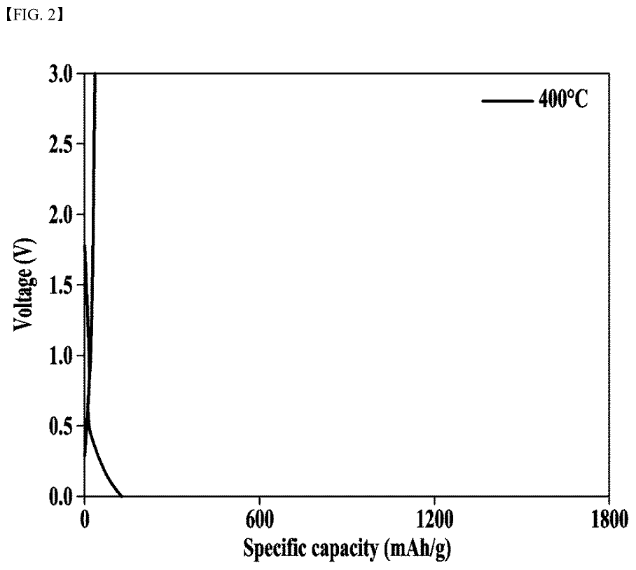

FIG. 1A illustrates the schematic diagram of a powder of a negative electrode active material precursor 10 manufactured according to an embodiment of the present disclosure. Referring to FIG. 1A, the powder of the negative electrode active material precursor 10 is composed of silica precursor particles 100 including an organic functional group and occupying the internal space of the powder; and a shell-shaped carbon layer 200 surrounding the silica precursor particles 100. In addition, the silica precursor 100 including the organic functional group is silica manufactured from an organically modified silane, and includes organic functional groups 101 indicated in green.

FIG. 1B illustrates the schematic diagram of a powder of a negative electrode active material intermediate 20 obtained by heat-treating the powder of the negative electrode active material precursor 10 according to an embodiment of the present disclosure in an inert gas atmosphere. Referring to FIG. 1B, the powder of the negative electrode active material intermediate 20 is composed of particles of a first silicon composite 120 occupying its internal space; and a shell-shaped carbon layer 200 surrounding the particles. The negative electrode active material intermediate 20 may include at least one of silica (SiO₂, not shown) and silicon oxide (SiOₓ) 110. Due to heat energy, the organic functional groups 101 of the silica precursor 100 is carbonized into the carbon particles 102, and the silica precursor 100 including the organic functional group is converted into the silica (SiO₂, not shown) or reduced to the silicon oxide (SiOₓ) 110. Here, the carbon particles 102 may be nano-sized carbon particles generated by thermal decomposition of the organic functional groups 101.

FIG. 1C illustrates the schematic diagram of a powder of a negative electrode active material 30 obtained by photo-processing the powder of the negative electrode active material intermediate 20 heat-treated according to an embodiment of the present disclosure. That is, FIG. 1C illustrates a result obtained by heat-treating the powder of the negative electrode active material precursor 10, and then photo-processing the powder. The powder of the negative electrode active material 30 is composed of a second silicon composite 121 occupying its internal space; and a shell-shaped carbon layer 200 configured to surround the second silicon composite 121 and subjected to photothermal treatment. The negative electrode active material 30 may include at least one of silica (SiO₂, not shown), silicon oxide (SiOₓ) 110; and silicon 111. When the negative electrode active material intermediate 20 is photo-processed, the carbon layer 210 and the carbon particles 102 absorb light, so that silica (SiO₂, not shown) may be reduced to the silicon oxide (SiOₓ) 110 through a reduction reaction, and the silicon oxide (SiOₓ) 110 may be reduced to silicon (Si) through a reduction reaction.

In the step of photo-processing the negative electrode active material intermediate, the carbon layer may absorb light energy instantly even if the photo-processing is only for a short time. A silicon-based material does not have a good light absorption rate when it exists alone, but if a material with excellent heat absorption or light absorption rate is introduced, sufficient light energy can be transmitted for the reduction of the silicon-based material. This allows for instantaneous high-temperature heat treatment, which allows for additional reduction of silica and silicon oxide, enabling the expression of high-capacity characteristics.

That is, through photo-processing, silica (SiO₂) with an oxidation number of 4 may be reduced to silicon oxide (SiOₓ) with a low oxidation number, or, if reduction occurs more, may be reduced to silicon (Si) with an oxidation number of 0. Accordingly, the second silicon composite may be composed of only silicon oxide, may be composed of only silicon, may be composed of silica and silicon oxide, may be composed of silicon oxide and silicon, may be composed of silica and silicon, or may be composed of silica, silicon oxide and silicon. The lower the oxidation number of silicon oxide or silicon included in the negative electrode active material, the higher the capacity characteristics may be exhibited.

According to an embodiment, the thickness of the carbon layer may be 0.5 nm to 100 nm. When the thickness of the carbon layer is thinner than 0.5 nm, sufficient light absorption is impossible during photo-processing. On the other hand, when the thickness of the carbon layer is thicker than 100 nm, the diffusion of lithium ions may be suppressed, thereby limiting the expression of high capacity at high current density.

According to an embodiment, the photo-processing may be white light irradiation or laser irradiation. Preferably, laser irradiation may be selected as the photo-processing. The photo-processing may be applied to films coated with powder or slurry.

According to an embodiment, the laser irradiation may be processed with a laser having a wavelength of 300 nm to 20 μm. The wavelength corresponds to ultraviolet light wavelength, visible light wavelength, near-infrared light wavelength, and mid-infrared light wavelength. If the laser is irradiated with a short wavelength of less than 300 nm, the energy of photons is too high, so the carbon layer may be decomposed in the air. On the other hand, when the laser is irradiated with a long wavelength exceeding 20 μm, the energy of photons is too weak to cause non-uniform photo-processing.

Preferably, the laser may be irradiated with a wavelength of 400 nm to 12 μm The wavelength corresponds to visible light wavelength, near-infrared light wavelength and mid-infrared light wavelength. In particular, since the mid-infrared light has a deeper penetration depth than light of a short wavelength, it is more suitable for homogeneous light processing for the first silicon composite.

According to an embodiment, the laser irradiation may be processed at an intensity of 1 W to 10 W. Preferably, the laser irradiation may be processed at an intensity of 2 W to 4 W. When the laser intensity is less than 2 W, the photo-processing effect is insufficient due to the low light energy. When the laser intensity exceeds 10 W, a defect is formed inside the first silicon composite, which causes deterioration of the electrochemical characteristics.

In addition, the laser irradiation may be processed at a speed of 10 mm/sec to 2,000 mm/sec, preferably at a speed of 50 mm/sec to 1,000 mm/sec. Here, the laser irradiation speed means the speed at which a laser irradiation part moves on the negative electrode active material intermediate. When the laser irradiation speed is less than 50 mm/sec, a defect is formed inside the first silicon composite due to the high light energy density, which causes deterioration of the electrochemical properties. When the laser irradiation speed exceeds 1000 mm/sec, the photo-processing effect is not sufficient due to low light energy.

Meanwhile, the organically modified silane may be one selected from the group consisting of triethoxyvinylsilane (TEVS), trimethoxyvinylsilane (TMVS), (3-mercaptopropyl)trimethoxysilane (MTMS), (3-mercaptopropyl)triethoxysilane (MTES), triethoxyethylsilane (TEES), methyltriethoxysilane (MTES), methyltrimethoxysilane (MTMS), 3-methacryloxypropyltrimethoxysilane (MPTMS), 3-methacryloxypropyltriethoxysilane (MPTES), (3-glycidyloxypropyl)trimethoxysilane (GPTMS), (3-glycidyloxypropyl)triethoxysilane (GPTES), phenyltriethoxysilane (PTES) and phenyltrimethoxysilane (PTMS). The organically modified silanes may include organic functional groups, a carbonization reaction may occur through an organic functional group, and light-absorbing particles (carbon particles) may be formed.

TEVS is preferred as an organically modified silane. Tetraethylorthosilicate (TEOS) only has an alkoxy functional group that can undergo hydration and condensation reactions, and does not contain an organic functional group. Since the organically modified silanes including TEVS contain an organic functional group along with an alkoxy functional group, carbon particles may be formed through a carbonization reaction after heat treatment. That is, since silica precursors manufactured from the organically modified silanes have a higher reduction rate to silicon oxide or silicon than silica precursors, manufactured from TEOS, during heat treatment or photo-processing under the same conditions, it is preferable to use TEVS.

The carbon layer is made of a material with good light absorption efficiency. For this, a carbon-based material may be used. More specifically, the carbon layer may be one selected from the group consisting of graphite, carbon nanotubes, graphene oxide, graphene, graphene nanoplatelet, and a carbon film deposited with hydrocarbon gas. Here, the hydrocarbon gas may be CH₄ or C₂H₆ gas. The carbon-based material itself is a material having the highest light absorption rate in a wavelength range of 300 nm to 20 μm. Preferably, graphene oxide may be selected as a carbon-based material. Due to the presence of a surface functional group included in graphene oxide, a uniform carbon layer may be formed on the surface of the first silicon composite when manufacturing the first silicon composite.

The negative electrode active material for secondary batteries according to the present disclosure is manufactured according to the method of manufacturing a negative electrode active material for secondary batteries according to the present disclosure, and includes a second silicon composite; carbon particles included in the second silicon composite; and a carbon layer covering the surface of the second silicon composite.

The negative electrode active material for secondary batteries is manufactured by performing photothermal treatment on the negative electrode active material precursor to synthesize the second silicon composite from the silica precursor including the organic functional group, and the silica precursor itself does not have a high light absorption rate, so it takes a long time to absorb external energy for reduction. Accordingly, the silica precursor is wrapped with a material having a high light absorption rate such that the amount of heat energy and light energy transferred to the silica precursor and the first silicon composite is increased even if light is processed for a short time.

According to an embodiment, the second silicon composite may include at least one of silica (SiO₂), silicon oxide (SiOₓ) and silicon (Si), where 0<x<2. The second silicon composite including silica whose at least a portion is reduced may be utilized as a negative electrode active material for secondary batteries including next-generation lithium secondary batteries due to the high-capacity characteristics (10 times or more compared to the capacity of a negative electrode active material including graphite) and fast charge/discharge speed of the silicon-based material. In addition, the shell-shaped carbon layer constituting the negative electrode active material according to the present disclosure may improve the structural stability of the negative electrode active material. Therefore, the volume expansion and contraction of the negative electrode active material during the charge and discharge reaction of the secondary battery may be prevented, thereby suppressing the occurrence of cracks. In particular, since the carbon layer includes the carbon-based material, it may increase the electrical conductivity of the negative electrode active material, and thus has the advantage of enabling rapid charging and discharging.

Meanwhile, a weight ratio of the carbon layer relative to the negative electrode active material intermediate may be 10% by weight to 40% by weight. When the weight ratio of the carbon layer is smaller than 10% by weight, sufficient light absorption is impossible. When the weight ratio of the carbon layer is greater than 40% by weight, the weight ratio of the first silicon composite or the second silicon composite is reduced, thereby limiting the high-capacity characteristics of the negative electrode active material.

According to an embodiment, the carbon layer may be one selected from the group consisting of graphite, carbon nanotubes, graphene oxide, graphene, graphene nanoplatelet and a carbon film deposited with hydrocarbon gas. Here, the hydrocarbon gas may be CH₄ or C₂H₆ gas. Preferably, graphene oxide may be selected as the carbon layer.

According to an embodiment, the negative electrode active material for secondary batteries may have an initial capacity of 950 mAh/g to 4,200 mAh/g. The initial capacity of the negative electrode active material containing only silica is 338 mAh/g, and compared to this, the negative electrode active material, in which silica further includes reduced silicon oxide or silicon, according to the present disclosure has a higher initial capacity, and thus a high-capacity secondary battery may be provided by using the negative electrode active material.

Hereinafter, the present disclosure will be described in more detail through examples. These examples are intended to explain the present disclosure in more detail, and the scope of the present disclosure is not limited by these examples.

### Comparative Example 1

Ethanol and water were mixed to a total weight of 243 in a volume ratio (ethanol/water) of 0.60, and then stirred for 5 minutes.

Next, 0.48 g of cetrimoniumbromide (CTAB) was added, followed by stirring for 5 minutes.

Next, 3.0 ml of triethoxyvinylsilane (TEVS) was added, followed by stirring for 10 minutes.

Next, 2.7 g of an ammonium hydroxide (NH₄OH) catalyst was added, followed by stirring for 5 minutes.

Next, 150 mg of PVP (m.w.=55,000) was added, followed by stirring at room temperature for 3 hours.

The stirred solution was centrifuged at 7000 rpm for 20 minutes, thereby obtaining a precipitate.

100 mg of the precipitate was dispersed in 200 g of water to prepare a mixture.

The mixture was added dropwise to 12.5 g of a graphene oxide (GO) dispersion solution (concentration: 2.0 mg/ml) while stirring the solution.

The stirred solution was centrifuged at 7000 rpm for 20 minutes, thereby obtaining a precipitate.

The precipitate was dried in an 80° C. vacuum oven to obtain a negative electrode active material precursor powder. Here, the thickness of the carbon layer constituting the negative electrode active material precursor powder was ˜1 nm.

The powder was heat-treated at 400° C. for 1 hour in an argon (Ar) atmosphere using a tube furnace, thereby obtaining a negative electrode active material powder.

The negative electrode active material powder, Super P and poly(acrylic acid) (PAA) were mixed in a ratio of 7:1:2 in a mortar, and then ethylene glycol (EG) was added thereto, thereby preparing a slurry.

The slurry was cast to a thickness of 100 μm on a copper foil, thereby obtaining an electrode.

The electrode was dried in an 80° C. vacuum oven for 12 hours, thereby obtaining a lithium ion battery negative electrode.

The negative electrode, a separator and a gasket were placed on a coin cell case, and four drops of 1.3 M LiPF₆ and an ethyl carbonate (EC)/ethyl methyl carbonate (EMC) electrolyte were added, and then a lithium positive electrode, a spacer, a wave spring were added in that order, followed by covering with a case to assemble a coin cell.

### Comparative Example 2

A negative electrode active material was manufactured in the same manner as in Comparative Example 1 except that heat treatment was performed at 600° C., and a coin cell was assembled using the negative electrode active material.

### Example 1

Ethanol and water were mixed to a total weight of 243 in a volume ratio (ethanol/water) of 0.60, and then stirred for 5 minutes.

Next, 0.48 g of cetrimoniumbromide (CTAB) was added, followed by stirring for 5 minutes.

Next, 3.0 ml of triethoxyvinylsilane (TEVS) was added, followed by stirring for 10 minutes.

Next, 2.7 g of an ammonium hydroxide (NH₄OH) catalyst was added, followed by stirring for 5 minutes.

Next, 150 mg of PVP (m.w.=55,000) was added, followed by stirring at room temperature for 3 hours.

The stirred solution was centrifuged at 7000 rpm for 20 minutes, thereby obtaining a precipitate.

100 mg of the precipitate was dispersed in 200 g of water to prepare a mixture.

The mixture was added dropwise to 12.5 g of a graphene oxide (GO) dispersion solution (concentration: 2.0 mg/ml) while stirring the solution.

The stirred solution was centrifuged at 7000 rpm for 20 minutes, thereby obtaining a precipitate.

The precipitate was dried in an 80° C. vacuum oven to obtain a negative electrode active material precursor powder. Here, the thickness of the carbon layer constituting the negative electrode active material precursor powder was ˜1 nm.

The powder was heat-treated at 400° C. for 1 hour in an argon (Ar) atmosphere using a tube furnace, thereby obtaining a negative electrode active material intermediate powder.

The negative electrode active material intermediate powder, Super P and poly(acrylic acid) (PAA) were mixed in a ratio of 7:1:2 in a mortar, and then ethylene glycol (EG) was added thereto, thereby preparing a slurry.

The slurry was cast to a thickness of 100 μm on a copper foil, thereby obtaining an electrode.

The electrode was repeatedly photoprocessed 5 times under the following conditions to reduce the negative electrode active material intermediate to a negative electrode active material: intensity: 3.0 W, wavelength: 10.6 μm, scan speed: 600 mm/sec, and CO₂ laser: 1000 PPI.

The electrode was dried in an 80° C. vacuum oven for 12 hours, thereby obtaining a lithium ion battery negative electrode.

The negative electrode, a separator and a gasket were placed on a coin cell case, and four drops of 1.3 M LiPF₆ and an ethyl carbonate (EC)/ethyl methyl carbonate (EMC) electrolyte were added, and then a lithium positive electrode, a spacer, a wave spring were added in that order, followed by covering with a case to assemble a coin cell.

### Comparative Example 3

A negative electrode active material was manufactured in the same manner as in Example 1 except that TEOS was added instead of TEVS, and a coin cell was assembled using the negative electrode active material.

### Example 2

A negative electrode active material was manufactured in the same manner as in Example 1 except that heat treatment was performed at 600° C., and a coin cell was assembled using the negative electrode active material.

### Example 3

A negative electrode active material was manufactured in the same manner as in Example 1 except that heat treatment was performed at 800° C., and a coin cell was assembled using the negative electrode active material.

### Example 4

A negative electrode active material was manufactured in the same manner as in Example 1 except that heat treatment was performed at 800° C. and the intensity of laser was 3.6 W, and a coin cell was assembled using the negative electrode active material.

### [Characteristic Evaluation 1] Initial Capacity Measurement

The coin cells of Comparative Examples 1 to 3 and Examples 1 to 4 were subjected to charging/discharging tests. The charging/discharging tests were performed at a charging/discharging rate of a current density 0.1 A/g in a voltage range of 0.01 to 3.0 V.

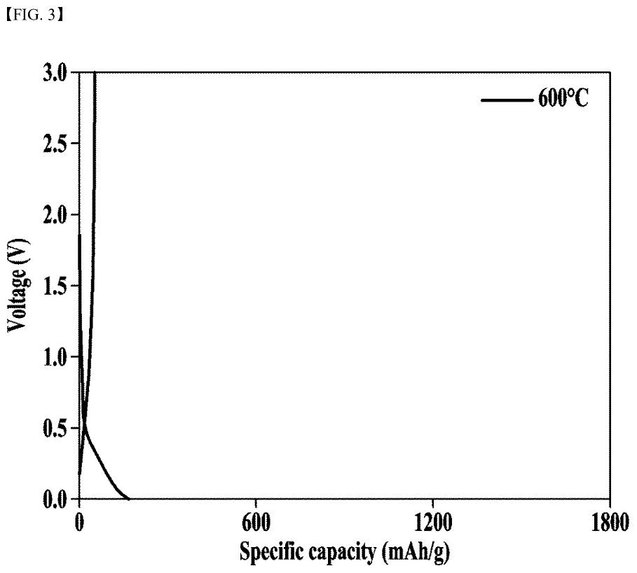

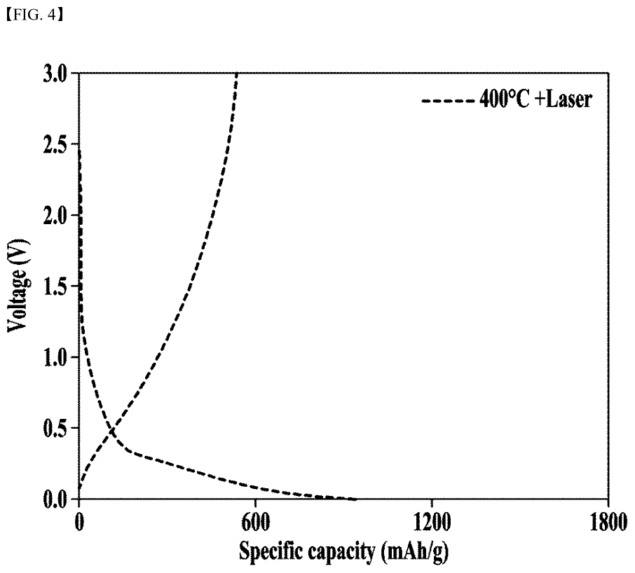

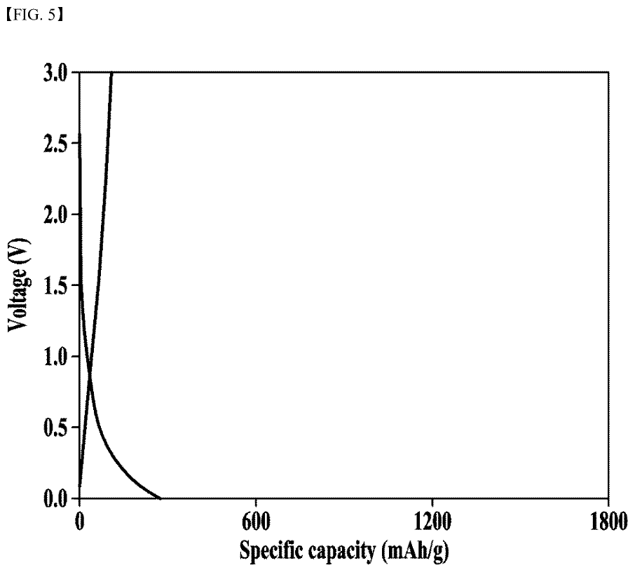

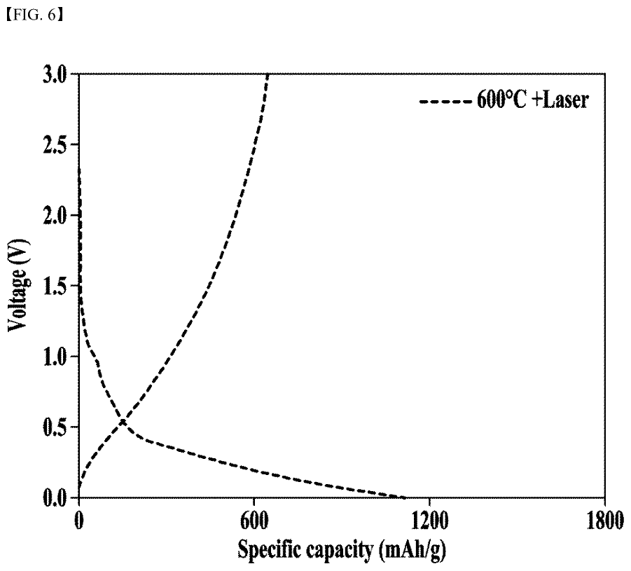

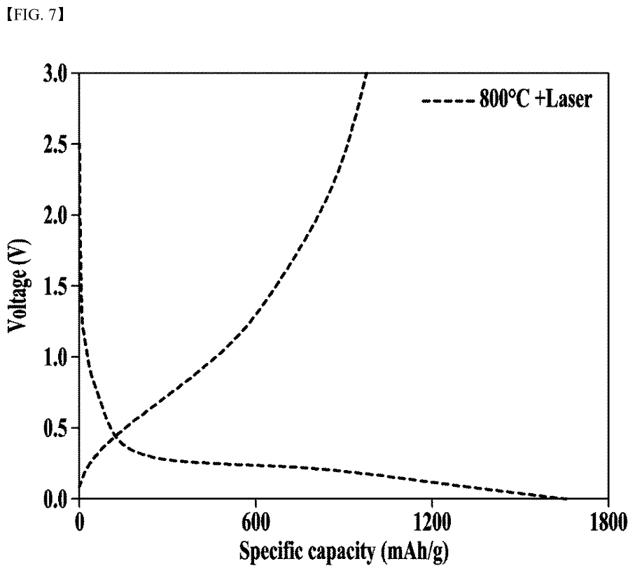

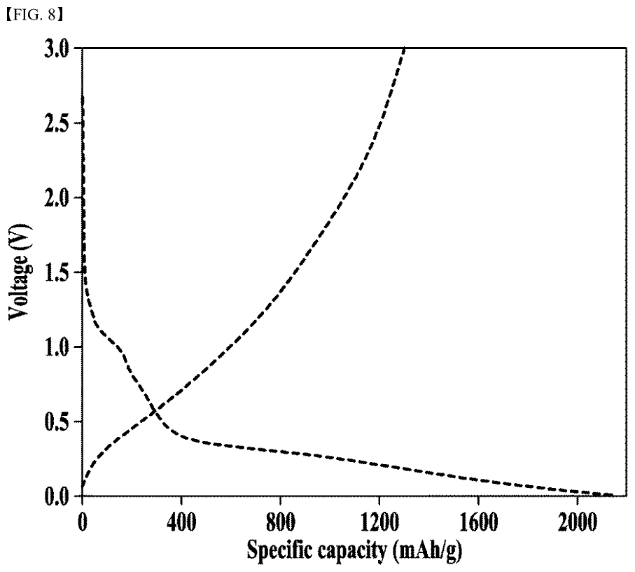

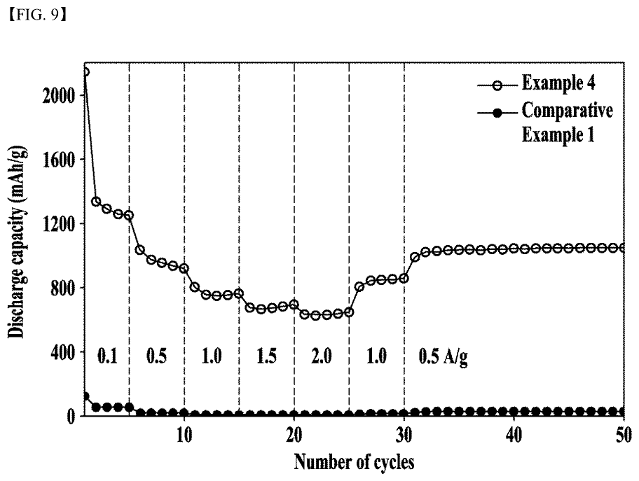

FIG. 2 illustrates the initial charge/discharge graph of the cell manufactured in Comparative Example 1, FIG. 3 illustrates the initial charge/discharge graph of the cell manufactured in Comparative Example 2, FIG. 4 illustrates the initial charge/discharge graph of the cell manufactured in Example 1, FIG. 5 illustrates the initial charge/discharge graph of the cell manufactured in Comparative Example 3, FIG. 6 illustrates the initial charge/discharge graph of the cell manufactured in Example 2, FIG. 7 illustrates the initial charge/discharge graph of the cell manufactured in Example 3, and FIG. 8 illustrates the initial charge/discharge graph of the cell manufactured in Example 4. Table 1 numerically represents FIGS. 2 to 8.

Referring to the drawings and tables, the comparative examples exhibit an initial capacity of 300 mAh/g or less, which is lower than a graphite anode active material whose disadvantage is low capacity. On the other hand, it can be confirmed that the examples exhibit a high initial capacity of 950 mAh/g to 2139 mAh/g and capacity characteristics that are much higher than in the comparative examples. Comparing Comparative Examples 1 and 2 using TEVS as an organically modified silane and the remaining examples, it can be confirmed that the initial capacity of the silicon composite was much higher when photothermal treatment was performed than when only heat treatment was performed.

The same photothermal treatment conditions were used in Example 2 and Comparative Example 3, but the initial capacity was much higher when used in Example 2. This is because, in the case of Comparative Example 3, TEOS, a silane, contains only an alkoxy functional group capable of hydration and condensation reactions and does not contain an organic functional group, but, in the case of Example 2, TEVS contains the organic functional group together with the alkoxy functional group. TEVS can form carbon particles through a carbonization reaction after heat treatment, and the carbon particles can induce homogeneous carbothermal reduction. Accordingly, when heat-treated or photo-processed under the same conditions, the ratio of reduction to silicon oxide or silicon in Example 2 is higher, so when applied as a negative electrode active material, it exhibits a higher initial capacity.

When comparing Example 2 with Example 3, the initial capacity increased as the heat treatment temperature increased, and when comparing Example 3 with Example 4, the initial capacity tended to increase as the laser intensity increased.

TABLE 1

| | | Photothermal | | |
|---|---|---|---|---|
| | | treatment | Initial | |
| | Silane | conditions | capacity | |
| Comparative | TEVS | General 400° C. | 121 | mAh/g |
| Example 1 | | | | |
| Comparative | TEVS | General 600° C. | 170 | mAh/g |
| Example 2 | | | | |
| Example 1 | TEVS | General 400° C. + | 950 | mAh/g |
| | | mid-infrared light | | |
| | | laser 3.0 W | | |
| Comparative | TEOS | General 600° C. + | 265 | mAh/g |
| Example 3 | | mid-infrared light | | |
| | | laser 3.0 W | | |
| Example 2 | TEVS | General 600° C. + | 1088 | mAh/g |
| | | mid-infrared light | | |
| | | laser 3.0 W | | |
| Example 3 | TEVS | General 800° C. + | 1658 | mAh/g |
| | | mid-infrared light | | |
| | | laser 3.0 W | | |
| Example 4 | TEVS | General 800° C. + | 2139 | mAh/g |
| | | mid-infrared light | | |
| | | laser 3.6 W | | |

### [Characteristic Evaluation 2] Capacity Measurement and Charging/Discharging Test

Capacity and long-term charging/discharging tests dependent upon the current density of each of the coin cells of Comparative Example 1 and Example 4 were performed. The charging/discharging tests were performed at a charging/discharging rate of current density 0.1 A/g in a voltage range of 0.01 to 3.0 V.

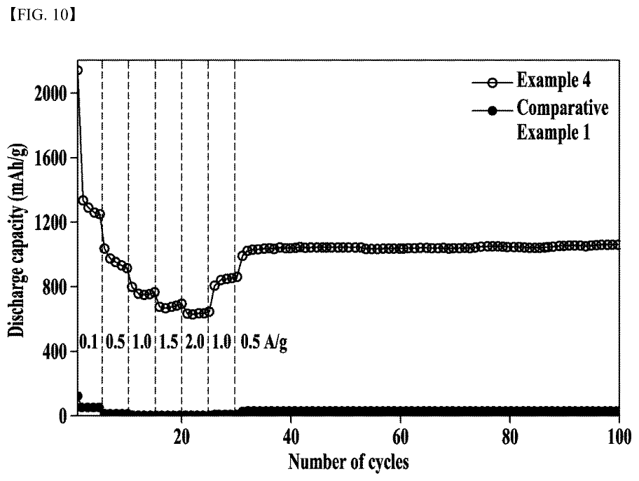

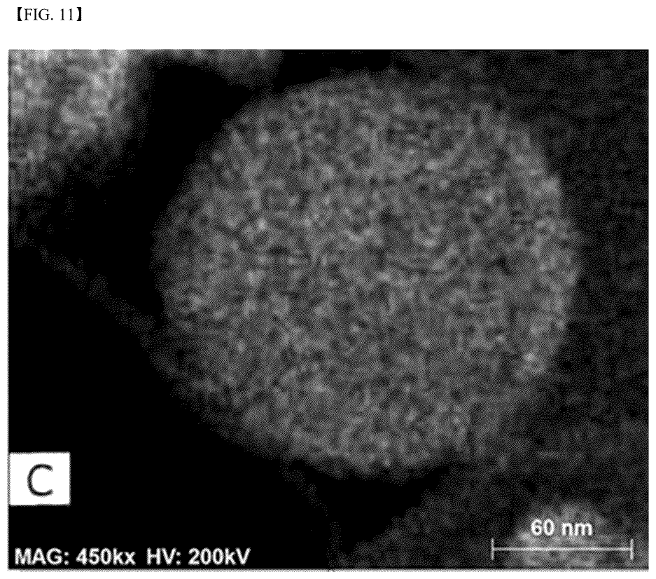

FIG. 9 illustrates the current density-dependent capacity measurement results of the cells manufactured in Comparative Example 1 and Example 4, and FIG. 10 illustrates the current density-dependent long-term charging/discharging measurement results of the cells manufactured in Comparative Example 1 and Example 4. Table 2 numerically represents FIGS. 9 and 10. Referring to FIG. 9 and Table 2, it can be confirmed that the capacity of Example 4, which was manufactured with the negative electrode active material having a high initial capacity, is significantly greater than that of Comparative Example 1 in all current density ranges. Referring to FIG. 10 and Table 2, it can also be confirmed that, even after 100 cycles, the capacity of Example 4 is greater than that of Comparative Example 1, and the capacity retention rate is high. That is, when photo-processing is performed in addition to heat treatment on silica, not only the initial capacity but also the subsequent capacity value is maintained higher than when heat treatment on silica is only performed.

TABLE 2

| | | | | | | | Capacity |
|---|---|---|---|---|---|---|---|
| | Initial | | | | | | after 100 |
| | capacity | Current density-dependent capacity (mAh/g) | | | | | cycles |
| | (mAh/g) | @ 0.1 | @ 0.5 | @ 1.0 | @ 1.5 | @ 2.0 | (mAh/g) |
| | @ 0.1 A/g | A/g | A/g | A/g | A/g | A/g | @ 0.5 A/g |
| Example 4 | 2139 | 1338 | 1037 | 803 | 676 | 633 | 1060 |
| Comparative | 121 | 56 | 23 | 13 | 10 | 8 | 36 |
| Example 1 | | | | | | | |

### [Characteristic Evaluation 3] Distribution of Carbon Particles

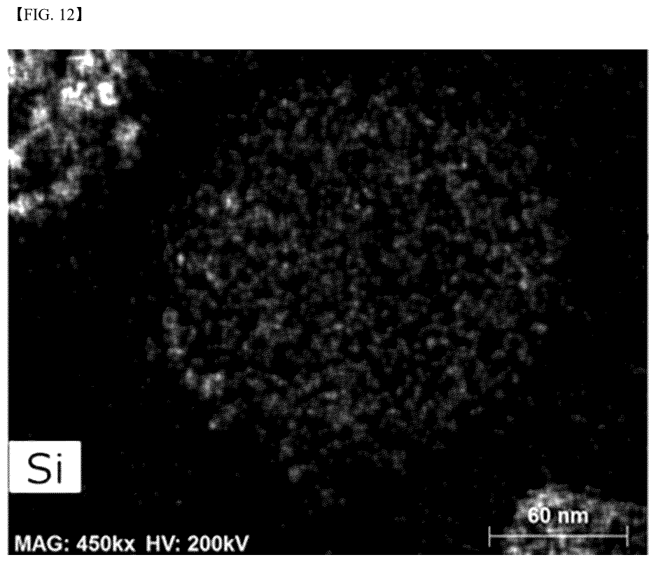

FIG. 11 illustrates the photograph of the carbon atoms (C) of Example 4 taken by energy-dispersive X-ray spectroscopy (EDS), and FIG. 12 illustrates the photograph of the silicon atoms (Si) of Example 4 taken by EDS. In addition, it was confirmed that, in Example 4, the weight ratio of carbon particles was 5 to 40% by weight, and the sizes of the carbon particles were 1 to 30 nm. FIG. 11 illustrates carbon particles dispersed in the negative electrode active material, and FIG. 12 illustrates the second silicon composite dispersed in the negative electrode active material. By comparing FIG. 11 with FIG. 12, it can be confirmed that the carbon particles are evenly distributed throughout the negative electrode active material, and the second silicon composite is located at positions where the carbon particles are located. This means that carbon particles that have absorbed external energy reduce the first silicon composite and, thus, induce the formation of the second silicon composite.

According to an embodiment of the present disclosure, a silica precursor can be sufficiently reduced to form a silicon composite even with instantaneous photo-processing by forming a carbon layer and carbon particles on a silica precursor including an organic functional group.

According to an embodiment of the present disclosure, silica (SiO₂), silicon oxide (SiOₓ, 0<x<2) or silicon (Si) can be synthesized by rapidly photo-processing a silica precursor including an organic functional group, and a secondary battery having high-capacity characteristics can be manufactured by using the silica (SiO₂), the silicon oxide (SiOₓ, 0<x<2) or the silicon (Si) as a negative electrode active material.

Although the present disclosure has been described through limited examples and drawings, the present disclosure is not intended to be limited to the examples. Those skilled in the art will appreciate that various modifications, additions and substitutions are possible, without departing from the scope and spirit of the disclosure. Therefore, it should be understood that there is no intent to limit the disclosure to the examples disclosed, rather, the disclosure is to cover all modifications, equivalents, and alternatives falling within the spirit and scope of the disclosure as defined by the claims. Therefore, the scope of the present disclosure should not be limited to the described examples, but should be defined not only by the claims described below but also by equivalents of these claims.

### DESCRIPTION OF SYMBOLS

10: negative electrode active material precursor
20: negative electrode active material intermediate
30: negative electrode active material
100: silica precursor including organic functional group
101: organic functional group
102: carbon particle
110: silicon oxide (SiOₓ)
120: first silicon composite
121: second silicon composite
200: carbon layer

What is claimed is:

1. A method of manufacturing a negative electrode active material for secondary batteries, the method comprising:
manufacturing a negative electrode active material precursor, the negative electrode active material precursor comprising a silica precursor comprising an organic functional group; and a carbon layer surrounding a surface of the silica precursor comprising the organic functional group;
heat-treating the negative electrode active material precursor to manufacture a negative electrode active material intermediate comprising a first silicon composite; and
photo-processing the negative electrode active material intermediate to manufacture a negative electrode active material comprising a second silicon composite.

2. The method according to claim 1, wherein the negative electrode active material intermediate comprises a first silicon composite; carbon particles contained in the first silicon composite; and the carbon layer surrounding a surface of the first silicon composite, and
the negative electrode active material comprises a second silicon composite, the carbon particles contained in the second silicon composite; and the carbon layer surrounding a surface of the second silicon composite.

3. The method according to claim 1, wherein the organic functional group is one selected from the group consisting of a vinyl group, a thiol group, a methyl group, an ethyl group, a phenyl group, an acryloxy group, a glycidyloxy group, and a mercapto group.

4. The method according to claim 2, wherein, in the heat-treating of the negative electrode active material precursor, the carbon layer absorbs heat so that the silica precursor comprising the organic functional group is reduced to the first silicon composite, and
the first silicon composite comprises at least one of silica (SiO₂) and silicon oxide (SiOₓ), where 0<x<2.

5. The method according to claim 2, wherein, in the heat-treating of the negative electrode active material precursor, the organic functional group is thermally decomposed and, thus, converted to the carbon particles.

6. The method according to claim 2, wherein, in the photo-processing of the negative electrode active material intermediate, the carbon layer and the carbon particles absorb light so that the first silicon composite is reduced to the second silicon composite, and
the second silicon composite comprises at least one of silica (SiO₂), silicon oxide (SiOₓ) and silicon (Si).

7. The method according to claim 1, wherein the heat treatment is performed at 300° C. to 1,500° C.

8. The method according to claim 1, wherein the carbon layer has a thickness of 0.5 nm to 100 nm.

9. The method according to claim 1, wherein the photo-processing is white light irradiation or laser irradiation.

10. The method according to claim 9, wherein the laser irradiation is performed with a laser having a wavelength of 300 nm to 20 μm.

11. The method according to claim 10, wherein the laser irradiation is performed with an intensity of 1 W to 10 W.

12. The method according to claim 1, wherein the carbon layer comprises one selected from the group consisting of graphite, carbon nanotubes, graphene oxide, graphene, graphene nanoplatelet and a carbon film deposited with hydrocarbon gas.

13. A negative electrode active material for secondary batteries, manufactured according to the method of claim 1.

14. The negative electrode active material according to claim 13, wherein the second silicon composite comprises at least one of silica (SiO₂), silicon oxide (SiOₓ) and silicon (Si),
where 0<x<2.

15. The negative electrode active material according to claim 13, wherein the carbon layer is one selected from the group consisting of graphite, carbon nanotubes, graphene oxide, graphene, graphene nanoplatelet and a carbon film deposited with hydrocarbon gas.

16. The negative electrode active material according to claim 13, wherein the negative electrode active material for secondary batteries has an initial capacity of 950 mAh/g to 4,200 mAh/g.
